(19) United States
(12) Patent Application Publication
(10) Pub. No.: US 2022/0326387 A1
(43) Pub. Date: Oct. 13, 2022

(54) SHIELDING RATE CALCULATING APPARATUS, SHIELDING RATE CALCULATING METHOD AND PROGRAM

(71) Applicant: NIPPON TELEGRAPH AND TELEPHONE CORPORATION, Tokyo (JP)

(72) Inventors: Kazuto GOTO, Musashino-shi, Tokyo (JP); Hideki TOSHINAGA, Musashino-shi, Tokyo (JP); Hideyuki TSUBOI, Musashino-shi, Tokyo (JP); Yushi SHIRATO, Musashino-shi, Tokyo (JP); Naoki KITA, Musashino-shi, Tokyo (JP)

(73) Assignee: NIPPON TELEGRAPH AND TELEPHONE CORPORATION, Tokyo (JP)

(21) Appl. No.: 17/635,308

(22) PCT Filed: Aug. 22, 2019
(86) PCT No.: PCT/JP2019/032731

§ 371 Date: Feb. 14, 2022

(51) Int. Cl. G01S 17/931; G01S 7/481

(52) U.S. Cl. CPC G01S 17/931; G01S 7/4817; H04W 24/08

(57) ABSTRACT

An aspect of the present invention provides a shield factor calculation apparatus including: a point cloud data selection unit that selects point cloud data that satisfies a condition from point cloud data acquired in a multiple-passing area that is a region through which a mobile body that acquires the point cloud data indicating a shielding object in a space between a transmitting station and a receiving station has passed a predetermined number of times or more from among areas through which the mobile body has passed; a voxel splitting unit that splits a Fresnel zone into a plurality of voxels with sizes in accordance with positions in the Fresnel zone, based on information indicating an acquisition condition when the point cloud data selected by the point cloud data selection unit is acquired and information indicating an acquisition condition when the point cloud data is acquired in an area other than the multiple-passing area; a calculation unit that calculates a shield factor of a radio wave based on a position, a shape, and a size of a voxel at a position indicated by at least either the point cloud data selected by the point cloud data selection unit or the point cloud data acquired in the area other than the multiple-passing area, from among the plurality of voxels.

### TECHNICAL FIELD

The present invention relates to a shield factor calculation apparatus, a shield factor calculation method, and a program.

### BACKGROUND ART

In the related art, a method of utilizing millimeter waves for communication network infrastructures is proposed by IEEE 802.11ay (NPL 1). On the other hand, discussion of a technique of utilizing three-dimensional point cloud data for monitoring infrastructures has advanced (NPL 2). For example, in one line-of-sight detection method using point cloud data, determination is made with the help of lattice voxels that are set with an even size when line-of-sight detection based on point cloud data is executed.

### CITATION LIST

### Non Patent Literature

NPL 1: D. Tujkovic et al., “Changes to IEEE 802.11ay in support of mmW Distribution Network Use Cases”, IEEE 802.11-17/1022r0 (July 2017), [online], [retrieved on Jul. 1, 2019], Internet <URL: https://mentor.ieee.org/802.11/dcn/17/11-17-1022-00-00ay-changes-to-ieee-802-11ay-in-support-of-mmw-mesh-network-use-cases.pptx>
NPL 2: NTT, “Spatial State Estimation Technique for Promoting Facility Maintenance Operations”, R&D Forum 2017, B-10, [online], [retrieved on Jul. 1, 2019], Internet <URL: http://www.ntt.co.jp/RD/active/201702/jp/pdf_jpn/02B-10_j.pdf>

### SUMMARY OF THE INVENTION

### Technical Problem

Some of such techniques of evaluating a radio wave shield factor using point cloud data, such as line-of-sight detection, use point cloud data acquired by a mobile mapping system (MMS). However, in such a case, the point cloud densities may vary according to a distance between a mobile body such as a vehicle and a shielding object or according to movement of a mobile body, such as depending on a moving velocity of the mobile body. Thus, in a case in which line-of-sight detection is performed on a Fresnel zone between wireless stations, it may not be possible to accurately evaluate a proportion of the shielding object if determination is performed based on a unique voxel size with no consideration of a difference in point cloud densities.

In view of the aforementioned circumstances, an object of the present invention is to provide a technique for improving accuracy of evaluation in a technique of evaluating a radio wave shield factor using point cloud data.

### Means for Solving the Problem

An aspect of the present invention provides a shield factor calculation apparatus including: a point cloud data selection unit configured to select point cloud data that satisfies a predetermined selection condition from point cloud data acquired by a mobile body that acquires the point cloud data indicating a shielding object in a space between a transmitting station and a receiving station in a multiple-passing area that is a region through which the mobile body has passed a predetermined number of times or more from among areas through which the mobile body has passed; a voxel splitting unit configured to split a Fresnel zone into a plurality of voxels with sizes corresponding to positions in the Fresnel zone, based on information indicating an acquisition condition when the mobile body acquires the point cloud data selected by the point cloud data selection unit and information indicating an acquisition condition when the mobile body acquires the point cloud data in an area other than the multiple-passing area; and a calculation unit configured to calculate a shield factor of a radio wave directed from the transmitting station to the receiving station based on a position, a shape, and a size of a shielding voxel that is a voxel at a position indicated by at least either the point cloud data selected by the point cloud data selection unit or the point cloud data acquired by the mobile body in the area other than the multiple-passing area, from among the plurality of voxels.

An aspect of the present invention provides a shield factor calculation method including: selecting point cloud data that satisfies a predetermined selection condition from point cloud data acquired by a mobile body that acquires the point cloud data indicating a shielding object in a space between a transmitting station and a receiving station in a multiple-passing area that is a region through which the mobile body has passed a predetermined number of times or more from among areas through which the mobile body has passed; splitting a Fresnel zone into a plurality of voxels with sizes corresponding to positions in the Fresnel zone, based on information indicating an acquisition condition when the mobile body acquires the point cloud data selected in the selecting of the point cloud data and information indicating an acquisition condition when the mobile body acquires the point cloud data in an area other than the multiple-passing area; calculating a shield factor of a radio wave directed from the transmitting station to the receiving station based on a position, a shape, and a size of a shielding voxel that is a voxel at a position indicated by at least either the point cloud data selected in the selecting of the point cloud data or the point cloud data acquired by the mobile body in the area other than the multiple-passing area, from among the plurality of voxels.

An aspect of the present invention provides a program that causes a computer to function as the aforementioned shield factor calculation apparatus.

### Effects of the Invention

According to the present invention, it is possible to provide a technique for improving accuracy of evaluation in the technique of evaluating a radio wave shield factor using point cloud data.

### BRIEF DESCRIPTION OF DRAWINGS

FIG. 1 is a diagram illustrating an exemplary functional configuration of a shield factor calculation apparatus according to a first embodiment.

FIG. 2 is a first explanatory diagram for explaining a method of acquiring point cloud data according to the first embodiment.

FIG. 3 is a second explanatory diagram for explaining the method of acquiring point cloud data according to the first embodiment.

FIG. 4 is an explanatory diagram for explaining a Fresnel zone.

FIG. 5 is a diagram illustrating an exemplary functional configuration of a control unit according to the first embodiment.

FIG. 6 is a flowchart illustrating an exemplary specific processing flow performed by the control unit to calculate a radio wave shield factor according to the first embodiment.

FIG. 7 is an explanatory diagram for explaining that a space between wireless stations is split into N subspaces by (N+1) splitting planes according to the first embodiment.

FIG. 8 is an explanatory diagram for explaining an approximate pillar according to the first embodiment.

FIG. 9 is a flowchart illustrating an exemplary specific processing flow of voxel size determination processing according to the first embodiment.

FIG. 10 is an explanatory diagram for explaining a point cloud data point Pc and a position Pr according to the first embodiment.

FIG. 11 is an explanatory diagram for explaining a relationship between an n-th approximate pillar voxel dataset and an approximate pillar voxel according to the first embodiment.

FIG. 12 is an explanatory diagram for explaining shielding voxels, normalization transformation, and a shielding plane according to the first embodiment.

FIG. 13 is a diagram illustrating an exemplary functional configuration of a shield factor calculation apparatus according to a second embodiment.

FIG. 14 is a diagram illustrating an exemplary functional configuration of a control unit according to the second embodiment.

FIG. 15 is an explanatory diagram for explaining a multiple-passing area according to the second embodiment.

FIG. 16 is a flowchart illustrating an exemplary processing flow executed by a point cloud data acquisition count determination unit according to the second embodiment.

FIG. 17 is a flowchart illustrating an exemplary subordinate count determination processing flow according to the second embodiment.

FIG. 18 is a diagram illustrating an exemplary result of classification according to the second embodiment.

FIG. 19 is a flowchart illustrating an exemplary specific processing flow performed by a point cloud data selection unit to select point cloud data according to the second embodiment.

FIG. 20 is a flowchart illustrating an exemplary processing flow executed by a point cloud data selection unit in a case in which a selection condition is a second selection condition according to a modification of the second embodiment.

FIG. 21 is a diagram illustrating an exemplary processing for calculating a density of target point cloud data according to the modification.

FIG. 22 is a flowchart illustrating an exemplary processing flow executed by the point cloud data selection unit in a case in which a selection condition is a third selection condition according to the modification of the second embodiment.

### DESCRIPTION OF EMBODIMENTS

### First Embodiment

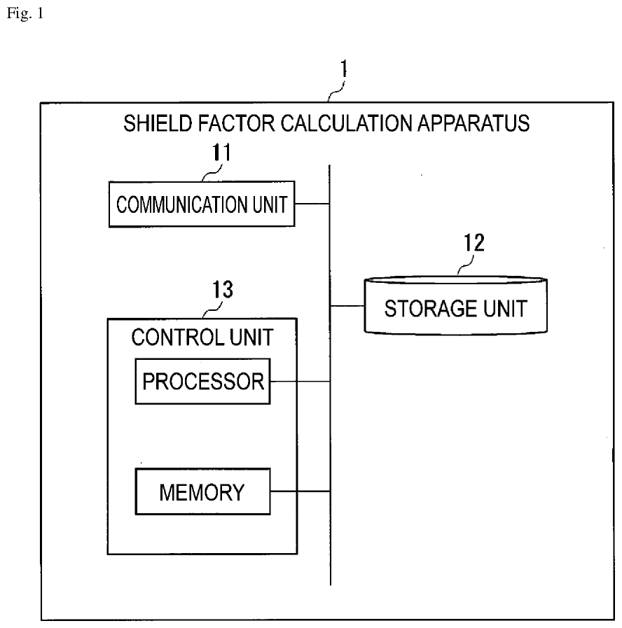

FIG. 1 is a diagram illustrating an exemplary functional configuration of a shield factor calculation apparatus 1 according to a first embodiment. The shield factor calculation apparatus 1 calculates a radio wave shield factor in a wireless communication system to be analyzed which includes two wireless stations, using point cloud data indicating a shielding object between the wireless stations. The radio wave shield factor is a proportion at which a radio wave emitted from a wireless station on a transmission side (hereinafter, referred to as a “transmitting station”) is shielded before arriving at a wireless station on a reception side (hereinafter, referred to as a “receiving station”).

Method for Acquiring Point Cloud Data

Here, a method for acquiring point cloud data used by the shield factor calculation apparatus 1 will be described.

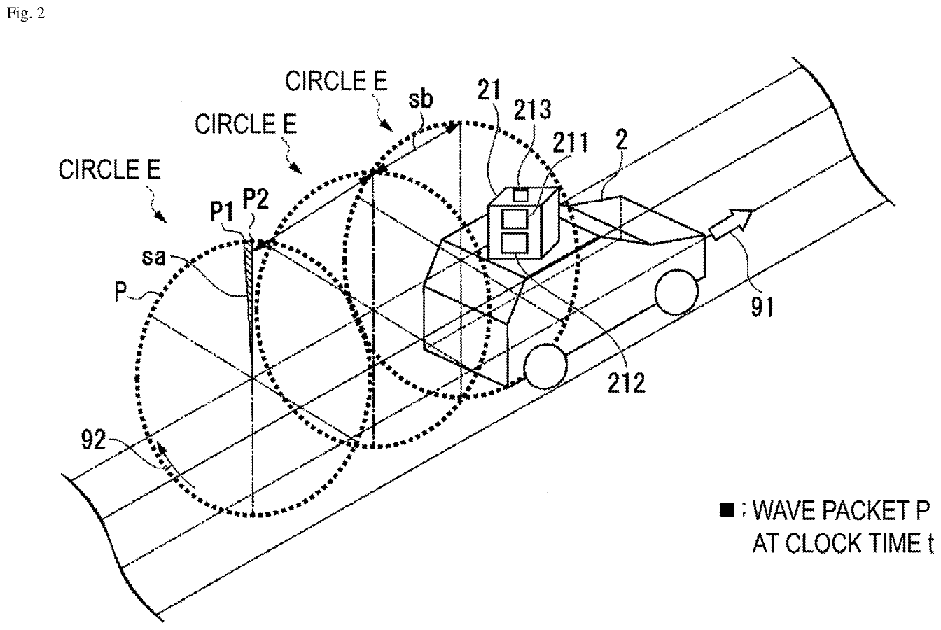

FIG. 2 is a first explanatory diagram for explaining a method for acquiring point cloud data according to the first embodiment. FIG. 2 illustrates a mobile body 2 and a three-dimensional laser scanner 21. The mobile body 2 may be, for example, an automobile, or a drone. In FIG. 2, the mobile body 2 moves in the direction of the arrow 91. The mobile body 2 includes a three-dimensional laser scanner 21. The three-dimensional laser scanner 21 moves along with the mobile body 2. The three-dimensional laser scanner 21 includes an emitting unit 211, a receiving unit 212, and a data acquisition unit 213. The emitting unit 211 intermittently emits a laser beam at a fixed cycle. The emitting unit 211 emits the laser beam while causing an orientation of the laser beam emission to rotate at a specific angular velocity. The receiving unit 212 receives a reflected wave of the laser beam emitted by the emitting unit 211. The data acquisition unit 213 acquires information indicating the position of the mobile body 2 at a clock time when the emitting unit 211 emits the laser beam (hereinafter, referred to as “traveling trajectory data”). The information indicating the position of the mobile body 2 is acquired by a global positioning system (GPS), for example. The data acquisition unit 213 calculates the position and the clock time at which the laser beam is reflected, based on information regarding the reflected wave received by the receiving unit 212 at a timing at which the receiving unit 212 receives the reflected wave. Hereinafter, the clock time at which the emitting unit 211 emits the laser beam will be referred to as a traveling trajectory data acquisition clock time. Hereinafter, the clock time at which the laser beam is reflected will be referred to as a point cloud data acquisition clock time.

More specifically, the three-dimensional laser scanner 21 emits a laser beam inside a plane (hereinafter, referred to as a “laser beam emitting plane”) located at a specific position when viewed from the apparatus itself. The three-dimensional laser scanner 21 changes an orientation of the emission at a specific angular velocity such that the orientation of the emission rotates by 2πK rad per unit time (K is a positive real number) in the laser beam emission plane. For example, the three-dimensional laser scanner 21 changes the emission orientation of the laser beam in the direction of the arrow 92. Because the three-dimensional laser scanner 21 intermittently emits the laser beam at a fixed cycle, the laser beam emitted by the three-dimensional laser scanner 21 is a wave packet P of electromagnetic waves intermittently emitted at a fixed cycle. FIG. 2 illustrates the position of the wave packet P at a clock time t. Because the wave packet P is emitted by the three-dimensional laser scanner 21 to rotate by 360° at a fixed cycle, the wave packet P forms a circle E. The wave packet P is reflected by a shielding object. A dataset of information (hereinafter, referred to as “point information”) indicating a position and a clock time at which the wave packet P is reflected (that is, a point cloud data acquisition clock time) is point cloud data. Note that in FIG. 2, the positions of a plurality of wave packets P emitted by the three-dimensional laser scanner 21 are illustrated by a plurality of circles E for simple explanation. However, the plurality of wave packets P forms a spiral in reality. The circles E in FIG. 2 are shapes schematically representing a single-turn spiral.

The three-dimensional laser scanner 21 receives the reflected wave of the emitted wave packet P and calculates a position and a clock time at which the received wave packet P is reflected based on the clock time and the position at which the wave packet P is reflected. A dataset of information indicating the positions and the clock times at which the wave packets P are reflected, which is calculated by the three-dimensional laser scanner 21, is point cloud data.

The moving velocity of the mobile body 2 affects a scan line interval sb. The scan line interval sb is a distance between two adjacent circles E. A figure formed by a wave packet P emitted during rotation of the laser beam emitting direction by 360° corresponds to one circle E. Thus, the scan line interval sb changes in accordance with the moving velocity of the mobile body 2.

Also, the distance between the mobile body 2 and the shielding object affects an adjacent point interval sa in the scan line. The adjacent point interval sa in the scan line indicates the distance between the position at which a wave packet P1 is reflected and the position at which a wave packet P2 is reflected. The wave packet P1 is one of the wave packets P while the wave packet P2 is a wave packet P emitted after the wave packet P1. Because the distances by which the wave packets P propagate until the wave packets P are reflected vary depending on the distance between the mobile body 2 and the shielding object, the distance between the mobile body 2 and the shielding object affects the adjacent point interval sa in the scan line.

In this manner, the scan line interval sb changes in accordance with the moving velocity of the mobile body 2, and the adjacent point interval sa in the scan line changes in accordance with the distance from the mobile body 2 to the shielding object. Thus, the density of the point cloud data differs in accordance with the moving velocity of the mobile body 2 and the distance from the mobile body 2 to the shielding object. The density of the point cloud data indicates the number of plotted points (hereinafter, referred to as “point cloud data points”) included in a unit cell in a virtual three-dimensional model in a case in which the positions indicated by point information are plotted in the virtual three-dimensional space.

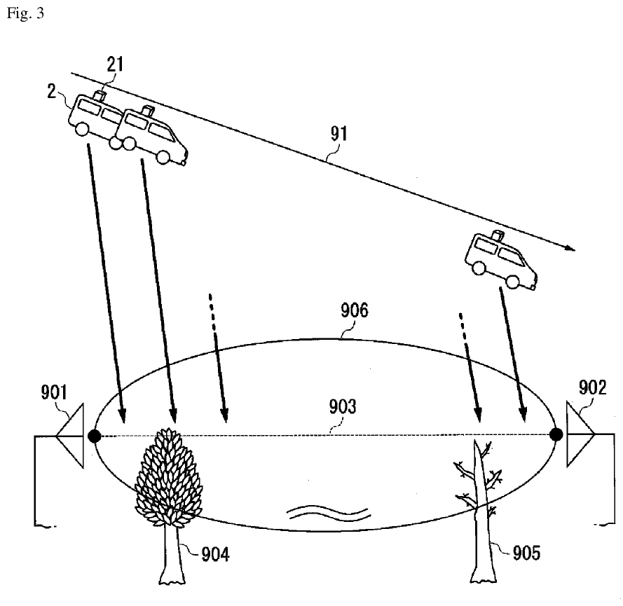

FIG. 3 is a second explanatory diagram for explaining the method for acquiring point cloud data according to the first embodiment. FIG. 3 illustrates a transmitting station 901 and a receiving station 902 in the wireless communication system that is an analysis target. FIG. 3 illustrates that the mobile body 2 including the three-dimensional laser scanner 21 is moving in the direction of the arrow 91. In FIG. 3, the straight line directed in the direction of the arrow 91 is not parallel to the line segment (hereinafter, referred to as a “station-connecting line segment 903”) connecting the transmitting station 901 and the receiving station 902. In FIG. 3, the three-dimensional laser scanner 21 emits a laser beam while moving. FIG. 3 illustrates that a time until a laser beam arrives at the station-connecting line segment 903 after the laser beam is emitted changes due to movement of the mobile body 2 because the straight line directed in the direction of the arrow 91 and the station-connecting line segment 903 are not parallel with each other. FIG. 3 illustrates that the distance between a first shielding object 904 or a second shielding object 905 and the mobile body 2 also changes due to movement of the mobile body 2. Note that the moving velocity of the mobile body 2 that acquires point cloud data may not be constant and the moving direction may not be constant.

Also, FIG. 3 illustrates a Fresnel zone 906 between the transmitting station 901 and the receiving station 902.

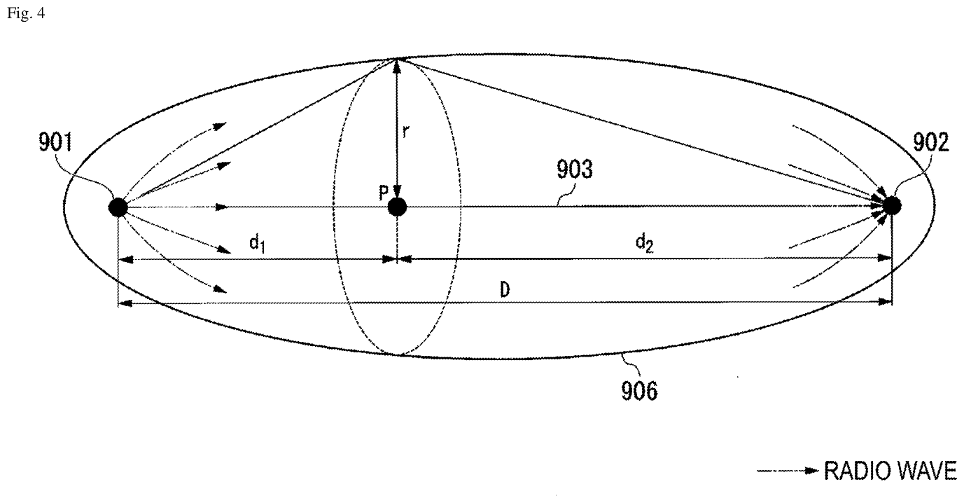

FIG. 4 is an explanatory diagram for explaining the Fresnel zone 906. The Fresnel zone 906 is a dataset of propagation paths until radio waves emitted from the transmitting station 901 arrive at the receiving station 902 in a case in which there are no objects that shield the radio waves emitted from the transmitting station 901 between the transmitting station 901 and the receiving station 902. As illustrated in FIG. 4, the radio waves are emitted from the transmitting station 901, spread, then converge, and arrive at the receiving station 902. The Fresnel zone 906 is a spheroid having the station-connecting line segment 903 as an axis. A radius r of a section of the Fresnel zone 906 that is perpendicular to the station-connecting line segment 903 and is located at a position a distance d₁ from the transmitting station 901 and a distance d₂ (=D−d₁) from the receiving station is represented by Expression (1) below. Note that D denotes the length of the station-connecting line segment 903. In Expression (1), λ denotes a wavelength of the radio wave.

$$\begin{matrix}[ Math . 1 ] & \\ r \approx \sqrt{λ \frac{{d}_{1} {d}_{2}}{{d}_{1} + {d}_{2}}} & ( 1 )\end{matrix}$$

The description of the method for acquiring point cloud data will end here, and description will return to FIG. 1.

The shield factor calculation apparatus 1 includes a display unit 10, a communication unit 11, a storage unit 12, and a control unit 13.

The display unit 10 displays a radio wave shield factor calculated by the control unit 13.
The communication unit 11 is configured to include a communication interface for connecting the apparatus itself to an external apparatus. The communication unit 11 communicates with the external apparatus in a wireless or wired manner. The communication unit 11 acquires various kinds of information output from the external apparatus. The external apparatus may be, for example, an input terminal such as a keyboard or a touch panel that a user can operate or a computer connected to an input terminal. The communication unit 11 acquires, for example, information indicating the positions of the transmitting station and the receiving station in the wireless communication system that is an analysis target (hereinafter, referred to as “wireless station information”) output from the external apparatus. The communication unit 11 outputs the acquired wireless station information to the control unit 13.

The storage unit 12 is configured to use a non-transitory computer-readable storage medium such as a magnetic hard disk device or a semiconductor storage device. The storage unit 12 stores, for example, point cloud data acquired in advance by the three-dimensional laser scanner 21 included in the mobile body 2. The storage unit 12 stores information indicating an acquisition condition when the mobile body 2 and the three-dimensional laser scanner 21 acquire point cloud data (hereinafter, referred to as “acquisition condition information”). The acquisition condition information includes traveling trajectory data. The three-dimensional laser scanner 21 is fixed to the mobile body 2, and the traveling trajectory data is thus information regarding movement of the three-dimensional laser scanner 21. The acquisition condition information includes information indicating an orientation of emission of laser wave packet emitted by the three-dimensional laser scanner 21 when the point cloud data is acquired (hereinafter, referred to as “emission orientation information”). The acquisition condition information includes information regarding a timing of emission of the laser wave packet emitted by the three-dimensional laser scanner 21 when the point cloud data is acquired (hereinafter, referred to as “emission timing information”). The emission orientation information may be, for example, information indicating a temporal change in orientation in which the wave packet is emitted. The emission orientation information may be, for example, information indicating an angular velocity at which the orientation of the emission of the wave packet rotates. The emission timing information may be, for example, information indicating a clock time at which the wave packet is emitted. The emission timing information may be information indicating an interval of the emission. In a case in which the emission timing information indicates a clock time of the emission, the clock time of the emission indicated by the emission timing information is the same as the traveling trajectory data acquisition clock time.

The control unit 13 is configured using a processor such as a central processing unit (CPU) and a memory. The control unit 13 operates by a program stored in the storage unit 12 being executed. More specifically, the processor included in the control unit 13 reads a program stored in the storage unit 12 and causes the memory to store the read program. The processor included in the control unit 13 operates by the program stored in the memory being executed. The control unit 13 controls operations of each functional unit included in the shield factor calculation apparatus 1 by executing the program. The control unit 13 calculates a radio wave shield factor in the wireless communication system that is an analysis target based on the point cloud data, for example, by the program being executed.

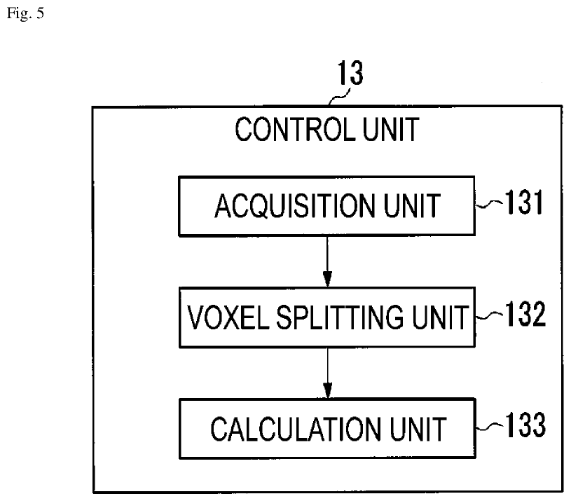

FIG. 5 is a diagram illustrating an exemplary functional configuration of the control unit 13 according to the first embodiment. The control unit 13 includes an acquisition unit 131, a voxel splitting unit 132, and a calculation unit 133. The acquisition unit 131 acquires various kinds of information needed to calculate the radio wave shield factor acquired by the communication unit 11 and various kinds of information needed to calculate the radio wave shield factor stored in the storage unit 12. The acquisition unit 131 acquires, for example, the point cloud data and the acquisition condition information. The voxel splitting unit 132 executes processing of splitting the Fresnel zone into a plurality of voxels with sizes in accordance with the acquisition condition information on a computer. The calculation unit 133 executes, on the computer, processing of calculating the radio wave shield factor based on the position, the shape, and the size of a voxel at the position indicated by the point cloud data from among the plurality of voxels split by the voxel splitting unit 132. Hereinafter, a case in which the voxel shape is a rectangular parallelepiped including a cube will be described as an example for simple explanation. However, the voxel may be a pillar with a regular polygonal bottom plane.

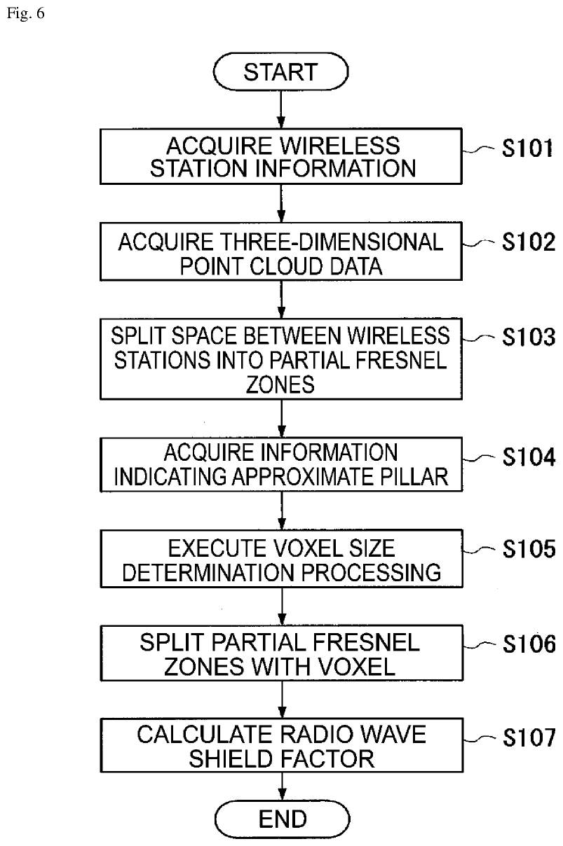

FIG. 6 is a flowchart illustrating an example of a specific processing flow performed by the control unit 13 to calculate the radio wave shield factor according to the first embodiment. Note that the transmitting station 901 and the receiving station 902 in each process illustrated in the flowchart in FIG. 6 are a transmitting station 901 and a receiving station 902 in a virtual space representing the transmitting station 901 and the receiving station 902 in an actual space.

The acquisition unit 131 acquires wireless station information (Step S101). Next, the acquisition unit 131 acquires point cloud data (Step S102). Next, the voxel splitting unit 132 splits a space between wireless stations into N (N is an integer that is equal to or greater than one) equal spaces (hereinafter, referred to as “subspaces”) in an orientation from the transmitting station 901 toward the receiving station 902 (Step S103). The space between the wireless stations is a space between the transmitting station 901 and the receiving station 902. More specifically, the control unit 13 splits the space between the wireless stations into N subspaces by (N+1) splitting planes. The splitting planes are planes that are located at equal intervals in a direction along the station-connecting line segment 903 and are perpendicular to the station-connecting line segment 903. Hereinafter, a subspace that is n-th (n is an integer that is equal to or greater than one and equal to or less than N) closest to the transmitting station from among the N subspaces will be referred to as the n-th subspace. Note that the number N according to which the space between the wireless stations is split may be received from the external apparatus via the communication unit 11 or may be stored in advance in the storage unit 12.

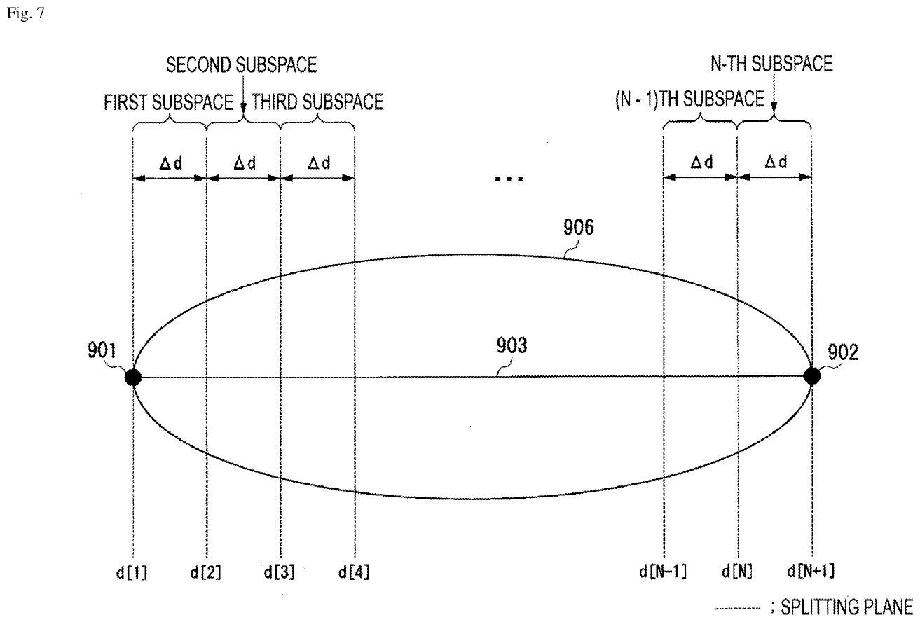

FIG. 7 is an explanatory diagram for explaining that the space between the wireless stations is split into N subspaces by the (N+1) splitting planes according to the first embodiment.

FIG. 7 illustrates that the space between the wireless stations including the Fresnel zone 906 is split into N spaces by (N+1) splitting planes located at positions of distances d[1] to d[N+1] from the transmitting station. d[1]=0, and d[N+1]=D. A difference between d[n+1] and d[n] is Δd. A space between the splitting plane at the position of d[n] and the splitting plane at the position of d[n+1] is the n-th subspace.

Description will be returned to FIG. 6. The voxel splitting unit 132 generates information indicating the position, the shape, and the size of an approximate pillar (hereinafter, referred to as “approximate pillar information”) for each partial Fresnel zone (Step S104). The partial Fresnel zones are N Fresnel zones 906 split by the splitting planes. Hereinafter, the partial Fresnel zone that is n-th closest to the transmitting station from among the N partial Fresnel zones will be referred to as the n-th pirtial Fresnel zone. In other words, the n-th partial Fresnel zone is a space in which the n-th subspace and the Fresnel zone 906 overlap with each other.

The approximate pillar is a pillar with a bottom plane that is perpendicular to the station-connecting line segment 903 and approximates the partial Fresnel zone. To approximate the partial Fresnel zone means that the pillar satisfies predetermined conditions regarding how close the shape and the size are to the shape and the size of the partial Fresnel zone (hereinafter, referred to as a “partial Fresnel zone approximation condition”). The partial Fresnel zone approximation condition is, for example, a condition that the n-th approximate pillar is inscribed in the n-th partial Fresnel zone. The n-th approximate pillar is a pillar included in the n-th subspace. The partial Fresnel zone approximation condition may be, for example, a condition that the n-th approximate pillar is circumscribed around the n-th partial Fresnel zone. The partial Fresnel zone approximation condition may be, for example, a condition that the section of the n-th approximate pillar that is parallel to the bottom plane of the n-th approximate pillar is inscribed in a central section of the n-th partial Fresnel zone (hereinafter, referred to as a “midpoint section condition”). The central section is a section of the n-th partial Fresnel zone on a plane that passes through the midpoint on the station-connecting line segment 903 in the n-th partial Fresnel zone and is perpendicular to the station-connecting line segment 903. The bottom plane of the approximate pillar may have, for example, a circular shape or a regular polygonal shape. In a case in which the bottom plane of the n-th approximate pillar is a circle, for example, the radius of the bottom plane of the n-th approximate pillar that satisfies the midpoint section condition is equal to the radius at the position of the center of the n-th partial Fresnel zone. Hereinafter, the shield factor calculation apparatus 1 will be described using, as an example, a case in which the n-th approximate pillar is a cylinder that satisfies the midpoint section condition for simple explanation.

The approximate pillar information may indicate, for example, the position, the shape, and the size of the approximate pillar using the positions of apexes of the approximate pillar. The approximate pillar information may indicate, for example, the position, the shape, and the size of the approximate pillar using the position of the center of gravity, the shape, and the size of the approximate pillar.

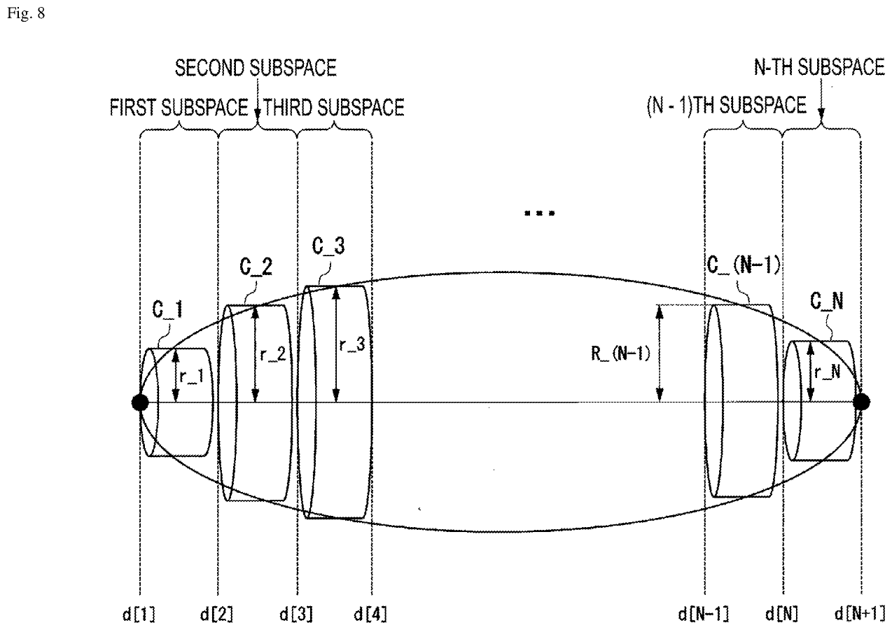

FIG. 8 is an explanatory diagram for explaining an approximate pillar according to the first embodiment.

In FIG. 8, a space in which the n-th subspace and the Fresnel zone overlap with each other is the n-th partial Fresnel zone. In FIG. 8, the n-th approximate pillar that approximates the n-th partial Fresnel zone is a cylinder C_n. The radius of the cylinder C_n is a radius r_n. The radius r_n is a radius r with which d₁ in Expression (1) satisfies Expression (2) below.

$$\begin{matrix}[ Math . 2 ] & \\ {d}_{1} = \frac{d [ n ] + d [ n + 1 ]}{2} & ( 2 )\end{matrix}$$

Description will be returned to FIG. 6. The voxel splitting unit 132 determines the size of the voxel for each subspace based on the acquisition condition information and the position, the shape, and the size of the partial Fresnel zone (Step S105). More specifically, the size of the bottom plane of the voxel is determined for each subspace. The voxel is a pillar and has a bottom plane that is perpendicular to the station-connecting line segment 903. The height of the voxel in the n-th subspace is equal to the length of the station-connecting line segment 903 in the n-th subspace. Hereinafter, the processing of determining the size of the voxel will be referred to as voxel size determination processing.

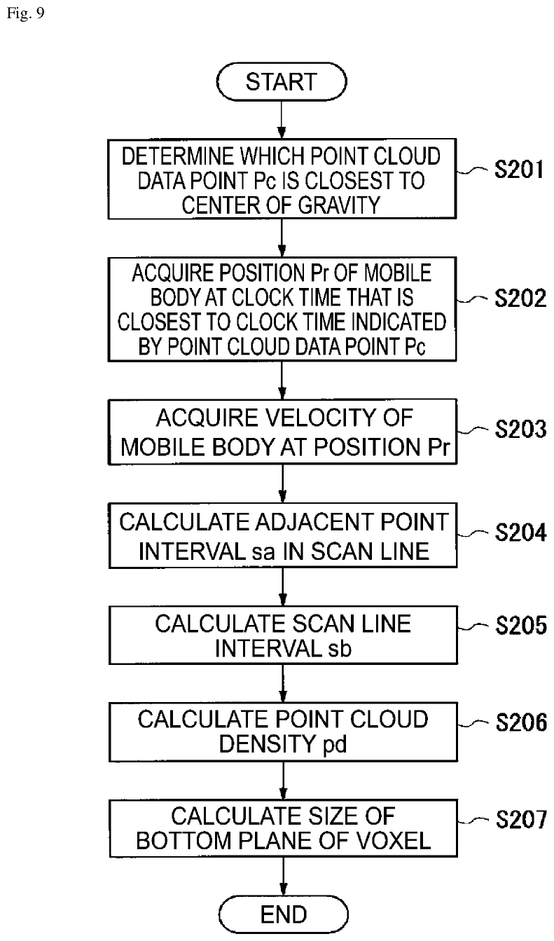

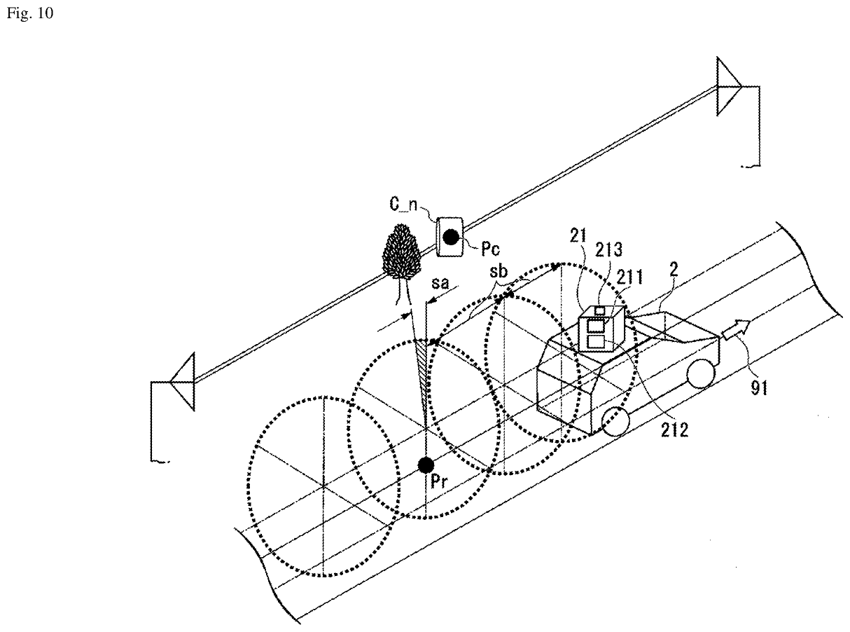

The voxel size determination processing in Step S105 will be described using FIGS. 9 and 10.

FIG. 9 is a flowchart illustrating an example of a specific processing flow for the voxel size determination processing according to the first embodiment. The voxel splitting unit 132 executes the processing illustrated in FIG. 9 for each n-th approximate pillar. FIG. 9 will be described using, as an example, a case in which the processing is executed for the n-th approximate pillar for simple explanation.

The voxel splitting unit 132 determines which point cloud data point is closest to the center of gravity of the n-th approximate pillar among point cloud data points (Step S201). Hereinafter, the point cloud data point that is determined to be closest to the center of gravity of the n-th approximate pillar in the processing in Step S201 will be referred to as a point cloud data point Pc. Next, the voxel splitting unit 132 acquires the position Pr of the three-dimensional laser scanner 21 at a clock time Pt that is closest to a clock time indicated by point information corresponding to the point cloud data point Pc based on the traveling trajectory data (Step S202).

FIG. 10 is an explanatory diagram for explaining the point cloud data point Pc and the position Pr according to the first embodiment. FIG. 10 illustrates that the point cloud data point Pc is located at the center of gravity of the cylinder C_n. FIG. 10 illustrates that the position Pr is on a moving path along which the mobile body 2 moves.

Description will be returned to FIG. 9. Next, the voxel splitting unit 132 calculates a velocity qr of the three-dimensional laser scanner 21 at the clock time Pt based on the traveling trajectory data (Step S203).

Next, the voxel splitting unit 132 calculates the adjacent point interval sa in the scan line based on the position of the point cloud data point Pc, the position Pr, the emission orientation information, and the emission timing information (Step S204). The adjacent point interval sa in the scan line is calculated by Expression (3) below.

[Math. 3]

sa=ω×R (3)

In Expression (3), ω denotes a measured angular pitch. The measured angular pitch ω is an angular velocity at which the orientation of the emission of the wave packet rotates. In Expression (3), R denotes the distance between the point cloud data point Pc and the position Pr.

Next, the voxel splitting unit 132 calculates the scan line interval sb based on the emission orientation information and the emission timing information (Step S205). The scan line interval sb is calculated by Expression (4) below.

$$\begin{matrix}[ Math . 4 ] & \\ sb = \frac{qr}{H} & ( 4 )\end{matrix}$$

In Expression (4), H denotes the laser beam rotation frequency. The laser beam rotation frequency is the number of times the laser scanner 21 rotates the orientation of the emission of the laser wave packet by 360° in unit time. In a case in which a dimension of the measured angular pitch ω is rad/second, for example, the laser beam rotation frequency H is ω/2π (Hz.

Next, the voxel splitting unit 132 calculates a point cloud density pd represented by Expression (5) below (Step S206). The point cloud density pd is a density of point cloud data points in the n-th partial Fresnel zone in a case in which the n-th partial Fresnel zone is filled with a shielding object.

$$\begin{matrix}[ Math . 5 ] & \\ pd = \frac{1}{sa \times sb} & ( 5 )\end{matrix}$$

Next, the voxel splitting unit 132 calculates the size of the bottom plane of the voxel in the n-th subspace based on the area of the bottom plane of the n-th approximate pillar and the point cloud density pd (Step S207). Specifically, the voxel splitting unit 132 acquires a value obtained by dividing the area of the bottom plane of the n-th approximate pillar by the point cloud density pd as the size of the bottom plane of the voxel in the n-th subspace. In a case in which the shape of the bottom plane of the voxel is a square shape, the length of one side of the bottom plane of the voxel in the n-th subspace is a square root of a value obtained by dividing the area of the bottom plane of the n-th approximate pillar by the point cloud density pd.

In this manner, the area of the bottom plane of the voxel in the n-th subspace is an inverse number of the point cloud density pd that is a density of the point cloud data points in the n-th partial Fresnel zone in a case in which the n-th partial Fresnel zone is filled with a shielding object. Thus, the section of a voxel that overlaps with the n-th partial Fresnel zone and that is perpendicular to the station-connecting line segment 903 includes one point cloud data point at most in the plane.

Description will be returned to FIG. 6. After Step S105, the voxel splitting unit 132 splits the partial Fresnel zone by the voxel with the size determined through the execution of the voxel size determination processing (Step S106). Next, the calculation unit 133 calculates the radio wave shield factor based on the position, the shape, and the size of the voxel at the position indicated by the point cloud data from among the voxels (hereinafter, referred to as a “shielding voxel”) (Step S107). Hereinafter, the processing executed by the calculation unit 133 in Step S107 will be referred to as radio wave shield factor calculation processing.

The calculation unit 133 determines whether or not each of all the voxels is an approximate pillar voxel first in the radio wave shield factor calculation processing. The approximate pillar voxel is a voxel with a degree of overlapping with the approximate pillar that is equal to or greater than a predetermined degree. The predetermined degree is greater than zero. The degree of zero means that there is no overlapping. The predetermined degree may differ for each approximate pillar or may be the same. Hereinafter, a dataset of approximate pillar voxels with overlapping with the n-th approximate pillar to a degree that is equal to or greater than the predetermined degree will be referred to as an n-th approximate pillar voxel dataset.

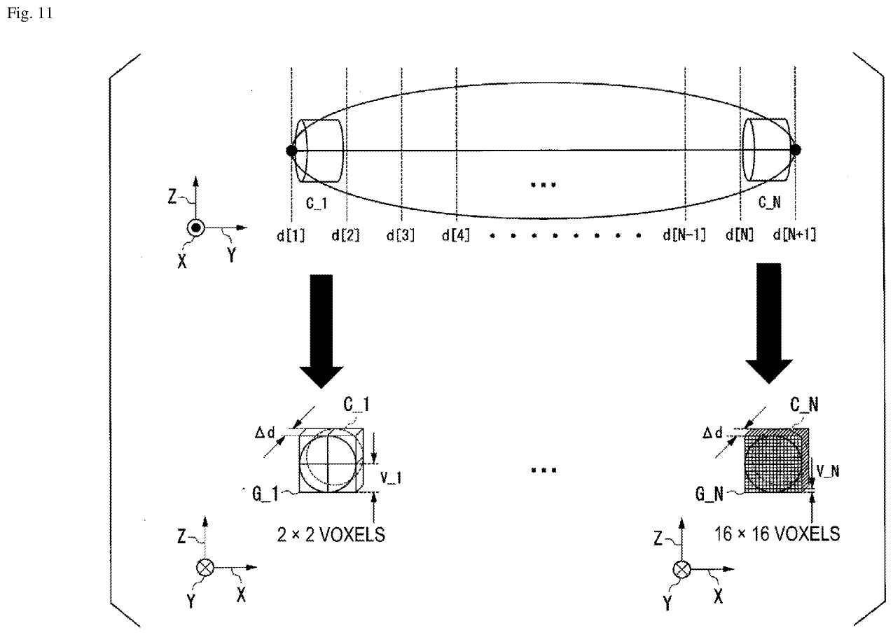

FIG. 11 is an explanatory diagram for explaining a relationship between the n-th approximate pillar voxel dataset and the approximate pillar voxel according to the first embodiment. FIG. 11 describes, as a specific example, a relationship of the first approximate pillar voxel dataset, the N-th approximate pillar voxel dataset, and the approximate pillar voxel. Specifically, FIG. 11 illustrates that the first approximate pillar voxel dataset G_1 is a dataset of 2×2 approximate pillar voxels, each voxel having a square with a side V_1 as a bottom plane and with a height Δd. FIG. 11 illustrates that the N-th approximate pillar voxel dataset G_N is a dataset of 16×16 approximate pillar voxels, each voxel having a square with a side V_N as the bottom plane and with a height Δd.

Next, the calculation unit 133 determines whether or not each of all the approximate pillar voxels includes the point cloud data point.

The calculation unit 133 transforms two bottom planes of all the approximate pillars into figures with the same size and shape (hereinafter, referred to as a “reference figure”) regardless of the n-th approximate pillar. The transformation of the bottom plane of the n-th approximate pillar into the reference figure will be referred to as an n-th normalization transformation. Hereinafter, normalization transformation is used for describing a case in which the first normalization transformation to the N-th normalization transformation are not distinguished from each other. The calculation unit 133 executes the n-th normalization transformation on the n-th approximate pillar voxel dataset as well. A dataset of a plurality of approximate pillars after the transformation (hereinafter, referred to as a “normalization pillar”) is a pillar. The shielding voxel is also transformed through the n-th normalization transformation. Hereinafter, the bottom plane of the shielding voxel after the transformation will be referred to as a shielding plane.

The calculation unit 133 acquires an area of one bottom plane of the normalization pillar with no shielding voxel after transformation in the height direction of the normalization pillar (hereinafter, referred to as a “shielding area”). In other words, the calculation unit 133 projects the bottom planes of all the shielding voxels from the first shielding voxel to the N-th shielding voxel to the reference figure and acquires the area of the figure projected to the reference figure (hereinafter, referred to as a “shielding figure”). The calculation unit 133 calculates the proportion of the shielding area (that is, the area of the shielding figure) with respect to the area of the one bottom plane of the normalization pillar (that is, the area of the reference figure). The calculated proportion is the radio wave shield factor.

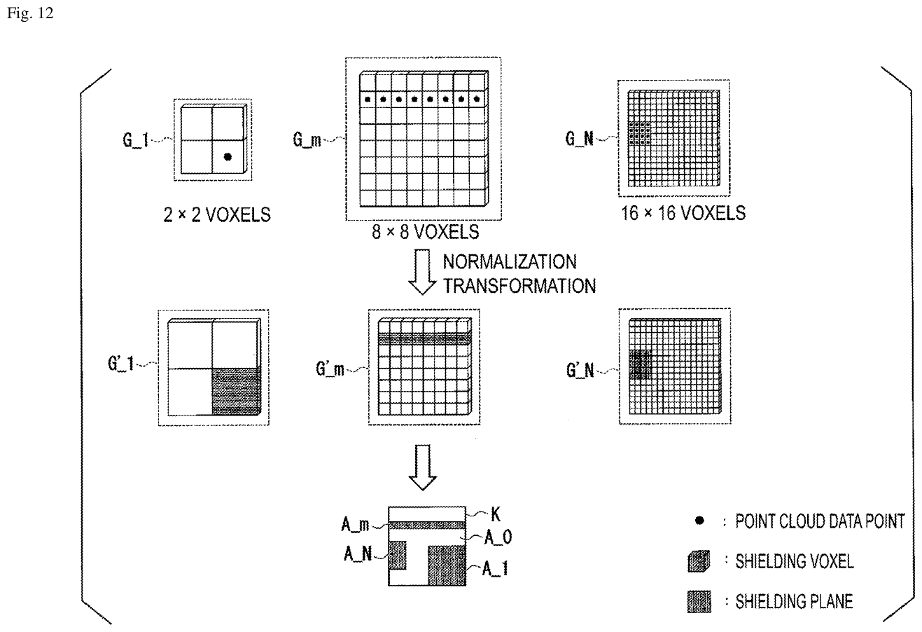

FIG. 12 is an explanatory diagram for explaining the shielding voxels, the normalization transformation, and the shielding plane according to the first embodiment.

FIG. 12 explains the radio wave shield factor calculation processing using the first approximate pillar voxel dataset G_1, the m-th approximate pillar voxel dataset (m is an integer that is equal to or greater than two and less than N) G_m, and the N-th approximate pillar voxel dataset G_N. In FIG. 12, the first approximate pillar voxel dataset G_1 is a dataset of 2×2 approximate pillar voxels, which is the same as that in FIG. 11. In FIG. 12, the N-th approximate pillar voxel dataset G_N is a dataset of 16×16 approximate pillar voxels, which is the same as that in FIG. 11. In FIG. 12, the m-th approximate pillar voxel dataset G_m is a dataset of 8×8 approximate pillar voxels. The size of the bottom plane of the first approximate pillar voxel dataset G_1 is different from the size of the bottom plane of the m-th approximate pillar voxel dataset G_m. In the first approximate pillar voxel dataset G_1, the m-th approximate pillar voxel dataset G_m, and the N-th approximate pillar voxel dataset G_N, dots in the approximate pillar voxels are point cloud data points. FIG. 12 illustrates, for example, that the point cloud data point is located at the lower right approximate pillar voxel in the first approximate pillar voxel dataset G_1. Thus, the lower right approximate pillar voxel of the first approximate pillar voxel dataset G_1 is the shielding voxel (first shielding voxel).

FIG. 12 illustrates the first approximate pillar voxel dataset G_1 after the first normalization transformation (hereinafter, referred to as a “first approximate pillar voxel dataset G′_1”). FIG. 12 illustrates the m-th approximate pillar voxel dataset G_m after the m-th normalization transformation (hereinafter, referred to as an “m-th approximate pillar voxel dataset G′_m”). FIG. 12 illustrates the N-th approximate pillar voxel dataset G_N after the N-th normalization transformation (hereinafter, referred to as an “N-th approximate pillar voxel dataset G′_N”). The bottom plane of the first approximate pillar voxel dataset G′_1, the bottom plane of the m-th approximate pillar voxel dataset G′_m, and the bottom plane of the N-th approximate pillar voxel dataset G′_N have the same shape and have the same area.

FIG. 12 illustrates the positions of a shielding plane A_1 of the first approximate pillar voxel dataset G′_1, a shielding plane A_m of the m-th approximate pillar voxel dataset G′_m, and a shielding plane A_N of the N-th approximate pillar voxel dataset G′_N on the reference figure K. The shielding area is an area of the region excluding, from the reference figure K, a non-shielding region A_0 in the region of the plane of the reference figure K. The non-shielding region A_0 is a region inside the plane of the reference figure K but the shielding plane A_1, the shielding plane A_m, or the shielding plane A_N.

The shield factor calculation apparatus according to the first embodiment configured as described above splits a Fresnel zone into a plurality of voxels with the sizes in accordance with the acquisition condition information indicating a condition when the point cloud data of the space between the wireless stations is acquired. Then, the shield factor calculation apparatus 1 calculates the radio wave shield factor in the space between the wireless stations based on the position, the shape, and the size of the shielding voxel that is a voxel at the position indicated by the point cloud data from among the plurality of voxels. The shield factor calculation apparatus 1 configured as described above can thus accurately calculate the radio wave shield factor between the wireless stations even in a case in which the distance between the mobile body 2 and the shielding object changes when the point cloud data is acquired.

### Modification Example of First Embodiment

Note that the point cloud data is not necessarily acquired by the three-dimensional laser scanner 21 fixed to the mobile body 2. The point cloud data may be acquired by a camera fixed to the mobile body 2, for example. In this case, the emission orientation information may be the orientation of the camera, and the emission timing information may be an imaging timing of the camera.

Note that the mobile body 2 including the three-dimensional laser scanner 21 is an example of the point cloud data acquisition system. Note that the shielding voxel transformed through the n-th normalization transformation is an example of the n-th shielding voxel. The shielding voxel in the first approximate pillar voxel dataset G′_1 in FIG. 12 is an example of the first shielding voxel. The shielding voxels in the N-th approximate pillar voxel dataset G′_N in FIG. 12 are examples of the N-th shielding voxels.

### Second Embodiment

The mobile body 2 may pass an area where the mobile body 2 has passed once to acquire point cloud data, again. In such a case, the number of items of the point cloud data acquired in the area where the mobile body 2 has passed a plurality of times is larger than the number of items of the point cloud data in the area where the mobile body 2 has passed once. Thus, the accuracy of the calculated shield factor becomes higher when only point cloud data that satisfies a predetermined selection condition is used without using all the items of the point cloud data for the area where the mobile body 2 has passed a plurality of times. This occurs not only in a case in which there are an area where the mobile body 2 has passed once and an area where the mobile body 2 has passed a plurality of times but also in a case in which the number of times the mobile body 2 has passed is different for each area.

Hereinafter, a shield factor calculation apparatus 1a that calculates a shield factor using only point cloud data that satisfies a predetermined selection condition will be described. Also, the predetermined selection condition will be described through the description of the shield factor calculation apparatus 1a.

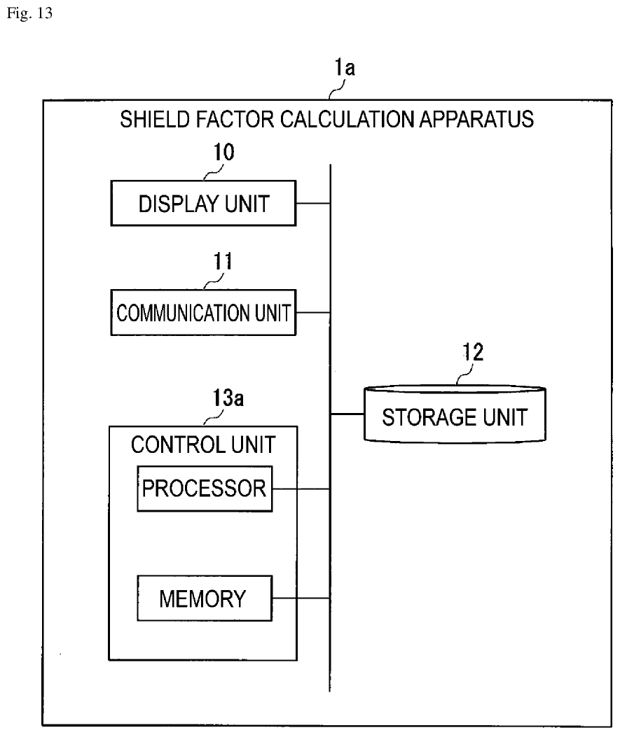

FIG. 13 is a diagram illustrating an exemplary functional configuration of the shield factor calculation apparatus 1a according to the second embodiment. The shield factor calculation apparatus 1a is different from the shield factor calculation apparatus 1 in that the shield factor calculation apparatus 1a includes a control unit 13a instead of the control unit 13. Hereinafter, reference signs similar to those in FIG. 1 will be applied to components that have similar functions as those in the shield factor calculation apparatus 1, and description thereof will be omitted.

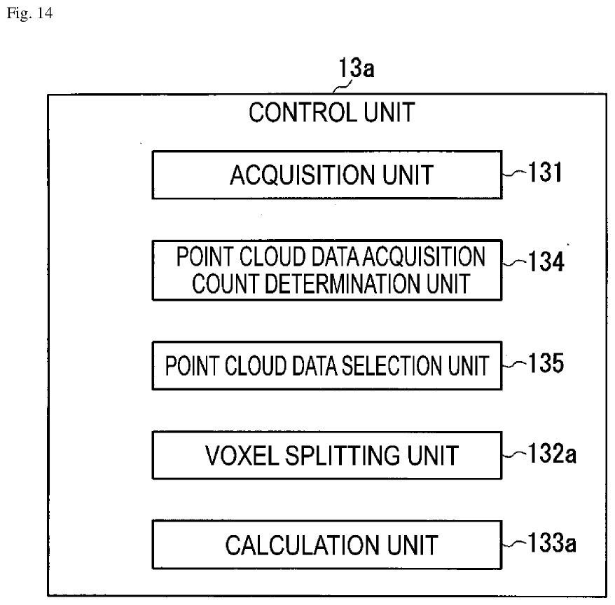

FIG. 14 is a diagram illustrating an exemplary functional configuration of the control unit 13a according to the second embodiment. The control unit 13a is different from the control unit 13 in that the control unit 13a includes a point cloud data acquisition count determination unit 134, the control unit 13a includes a point cloud data selection unit 135, the control unit 13a includes a voxel splitting unit 132a instead of the voxel splitting unit 132, and the control unit 13a includes a calculation unit 133a instead of the calculation unit 133. Hereinafter, reference signs similar to those in FIG. 5 will be applied to components that have similar functions as those in the shield factor calculation apparatus 1, and description thereof will be omitted.

The point cloud data acquisition count determination unit 134 determines whether or not the number of times the mobile body 2 has passed through a small area is equal to or greater than a predetermined number of times based on traveling trajectory data included in acquisition condition information acquired by the acquisition unit 131. The small area is each region in a case in which the entire area where the mobile body 2 has passed is split into a plurality of regions to satisfy a predetermined condition regarding splitting (hereinafter, referred to as a “splitting condition”). The splitting condition is, for example, a condition that the length that is parallel to the moving direction of the mobile body 2 is a distance by which the mobile body 2 moves in a specific time and the length in a direction perpendicular to the moving direction is a road width. The splitting condition is, for example, a condition that the number of small areas is U (U is an integer that is equal to or greater than two), the length of the small area in the moving direction of the mobile body 2 is the same for any of the small areas, and the length in the direction perpendicular to the moving direction is a road width.

The point cloud data selection unit 135 selects point cloud data that satisfies a predetermined selection condition for a small area where the mobile body 2 has passed a predetermined number of times or more (hereinafter, referred to as a “multiple-passing area”) based on a result of the determination performed by the point cloud data acquisition count determination unit 134. The predetermined selection condition is, for example, a first selection condition described below.

The first selection condition is a condition that the point cloud data is acquired by the mobile body 2 at a clock time indicated by a traveling trajectory data point belonging to a first target cluster. The first target cluster is a cluster that satisfies the following first cluster condition in a case in which a plurality of traveling trajectory data points when the mobile body 2 passes through the multiple-passing area (at the time of passing) are classified into a plurality of clusters based on the clock times indicated by the traveling trajectory data points. The first cluster condition is a condition that the number of elements is the largest from among the plurality of clusters obtained as a result of the classification. The traveling trajectory data points are information indicating the positions of the mobile body 2 and the clock times at which the mobile body 2 is present at the positions. A dataset of the traveling trajectory data points is traveling trajectory data. The clock times indicated by the traveling trajectory data points are the same as the clock times at which the emitting unit 211 emits laser beams.

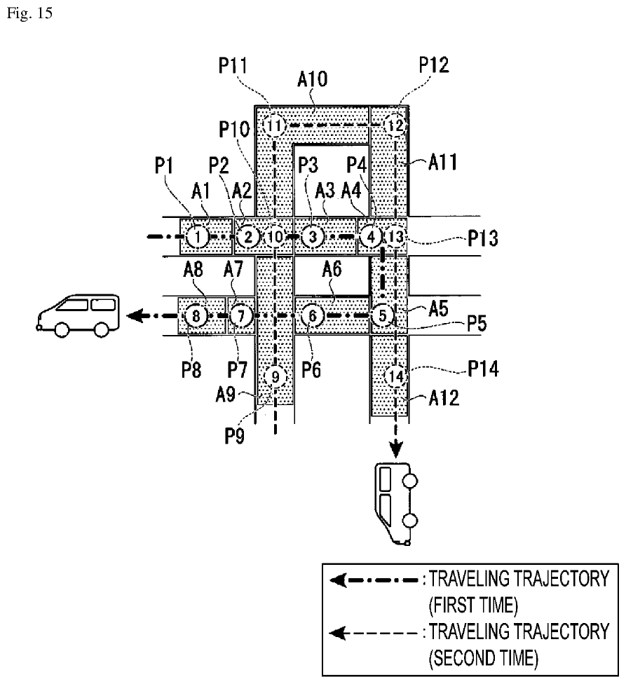

FIG. 15 is an explanatory diagram for explaining the multiple-passing area according to the second embodiment. FIG. 15 illustrates that the mobile body 2 moves in the order of a position P1, a position P2, a position P3, a position P4, a position P5, a position P6, a position P7, and a position P8. FIG. 15 illustrates that the mobile body 2 moves in the order of a position P9, a position P10, a position P11, a position P12, a position P13, and a position P14 thereafter. The positions P1 to P14 are the positions at which the traveling trajectory data of the mobile body 2 is acquired.

In FIG. 15, the position P1 is a position inside a small area A1. In FIG. 15, the position P2 is a position inside a small area A2. In FIG. 15, the position P3 is a position inside a small area A3. In FIG. 15, the position P4 is a position inside a small area A4. In FIG. 15, the position P5 is a position inside a small area A5. In FIG. 15, the position P6 is a position inside a small area A6. In FIG. 15, the position P7 is a position inside a small area A7. In FIG. 15, the position P8 is a position inside a small area A8. In FIG. 15, the position P9 is a position inside a small area A9. In FIG. 15, the position P10 is a position inside a small area A2. In FIG. 15, the position P11 is a position inside a small area A10. In FIG. 15, the position P12 is a position inside a small area A11. In FIG. 15, the position P13 is a position inside a small area A4. In FIG. 15, the position P14 is a position inside a small area A12.

In FIG. 15, the position P2 and the position P10 are located inside the small area A2. Thus, the small area A2 is a multiple-passing area. In FIG. 15, the position P4 and the position P13 are located inside the small area A4. Thus, the small area A4 is a multiple-passing area.

The voxel splitting unit 132a is different from the voxel splitting unit 132 in that the voxel splitting unit 132a splits a Fresnel zone into a plurality of voxels based on modified acquisition condition information instead of the acquisition condition information. The modified acquisition condition information includes information indicating an acquisition condition when point cloud data that satisfies the selection condition in the acquisition condition information is acquired. The modified acquisition condition information includes information indicating the acquisition condition when the mobile body 2 acquires the point cloud data in a small area other than the multiple-passing area. However, the modified acquisition condition information does not include information indicating the acquisition condition other than the acquisition condition when the point cloud data that satisfies the selection condition is acquired from among acquisition conditions when the mobile body 2 in the multiple-passing area acquires the point cloud data.

The calculation unit 133a is different from the calculation unit 133 in that the calculation unit 133a calculates a radio wave shield factor based on modified point cloud data instead of point cloud data. The modified point cloud data includes point cloud data selected by the point cloud data selection unit 135 and point cloud data acquired by the mobile body 2 in an area other than the multiple-passing area. However, the modified point cloud data does not include point cloud data other than the point cloud data selected by the point cloud data selection unit 135 from among the point cloud data acquired by the mobile body 2 in the multiple-passing area.

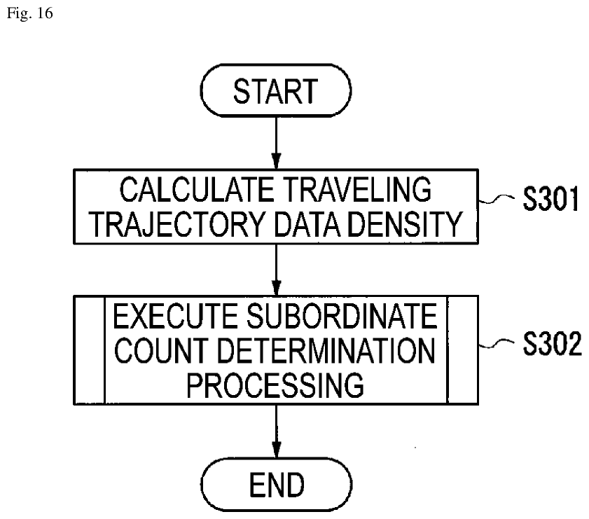

FIG. 16 is a flowchart illustrating an exemplary processing (hereinafter, referred to as “main count determination processing”) flow executed by the point cloud data acquisition count determination unit 134 according to the second embodiment. The flow in FIG. 16 is executed after execution of the processing in Step S101 and Step S102 illustrated in FIG. 6.

The point cloud data acquisition count determination unit 134 calculates a traveling trajectory data density for each small area (Step S301). The traveling trajectory data density is a value obtained by dividing the number of times the mobile body 2 has passed through a small area by an area of the small area.

Next, the point cloud data acquisition count determination unit 134 executes subordinate count determination processing for all small areas (Step S302).

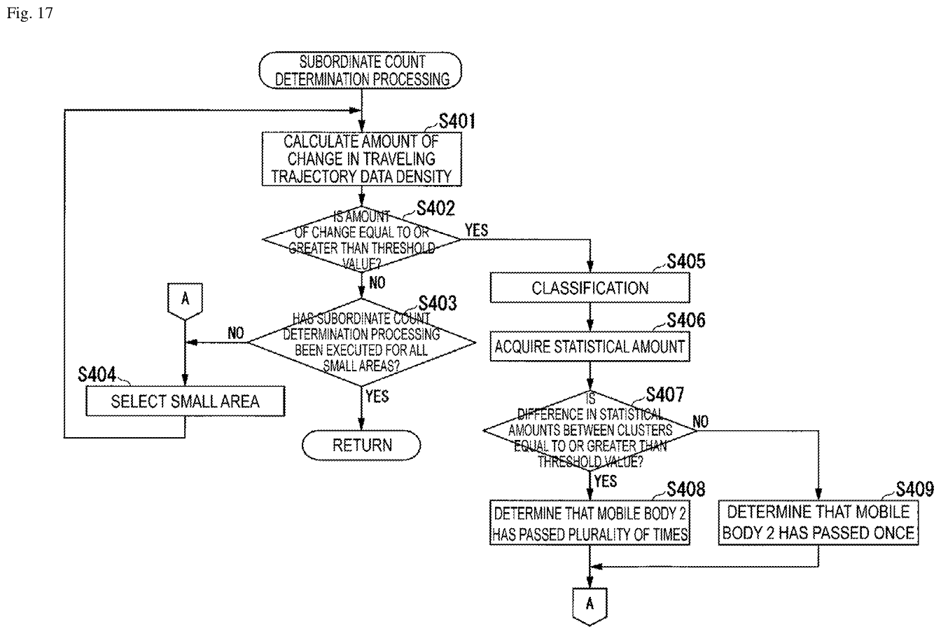

FIG. 17 is a flowchart illustrating an exemplary subordinate count determination processing flow according to the second embodiment.

The point cloud data acquisition count determination unit 134 acquires the amount of change in traveling trajectory data density between areas, namely between the i-th small area (i is an integer that is equal to or greater than one and equal to or less than U) and the (i+1)-th small area (Step S401). The i-th small area is a small area where the mobile body 2 has passed at the i-th earliest clock time. The amount of change is a value obtained by subtracting the traveling trajectory data density of the i-th small area from the traveling trajectory data density of the (i+1)-th small area, for example.

Here, an example of a traveling trajectory data density will be described using FIG. 15. In a case in which the mobile body 2 moves along a path illustrated in FIG. 15, a change in traveling trajectory data density between small areas is specifically the following change. The traveling trajectory data density of the small area A2 is double the traveling trajectory data density of the small area A1. The traveling trajectory data density of the small area A3 is 0.5 times the traveling trajectory data density of the small area A2. The traveling trajectory data density of the small area A4 is double the traveling trajectory data density of the small area A3. The traveling trajectory data density of the small area A5 is 0.5 times the traveling trajectory data density of the small area A4. The traveling trajectory data density of the small area A6 is one time the traveling trajectory data density of the small area A5. The traveling trajectory data density of the small area A7 is one time the traveling trajectory data density of the small area A6. The traveling trajectory data density of the small area A8 is one time the traveling trajectory data density of the small area A7.

The traveling trajectory data density of the small area A9 is one time the traveling trajectory data density of the small area A8. The traveling trajectory data density of the small area A10 is double the traveling trajectory data density of the small area A9. The traveling trajectory data density of the small area A11 is 0.5 times the traveling trajectory data density of the small area A10. The traveling trajectory data density of the small area A12 is one time the traveling trajectory data density of the small area A11. The traveling trajectory data density of the small area A13 is double the traveling trajectory data density of the small area A12. The traveling trajectory data density of the small area A14 is 0.5 times the traveling trajectory data density of the small area A12.

After Step S401, the point cloud data acquisition count determination unit 134 determines whether or not the amount of change in traveling trajectory data density is equal to or greater than a threshold value (Step S402). In a case in which the amount of change in traveling trajectory data density is less than the threshold value (Step S402: NO), the point cloud data acquisition count determination unit 134 determines whether or not the subordinate count determination processing has been performed on all the small areas (Step S403). In a case in which the subordinate count determination processing has been executed on all the small areas (Step S403: YES), the processing is ended.

On the other hand, in a case in which the subordinate count determination processing has not been ended for all the small areas (Step S403: NO), execution of the subordinate count determination processing is started for small areas on which the subordinate count determination processing has not been executed, from among the small areas except for the first small area. Specifically, one of the small areas on which the subordinate count determination processing has not been executed is selected first from among the small areas except for the first small area (Step S404). Next, the processing returns to Step S401.

In a case in which the amount of change in traveling trajectory data density is equal to or greater than the threshold value (Step S402: YES), the point cloud data acquisition count determination unit 134 classifies the traveling trajectory data acquired in the (i+1)-th small area into a plurality of clusters based on the traveling trajectory data acquisition clock time (Step S405).

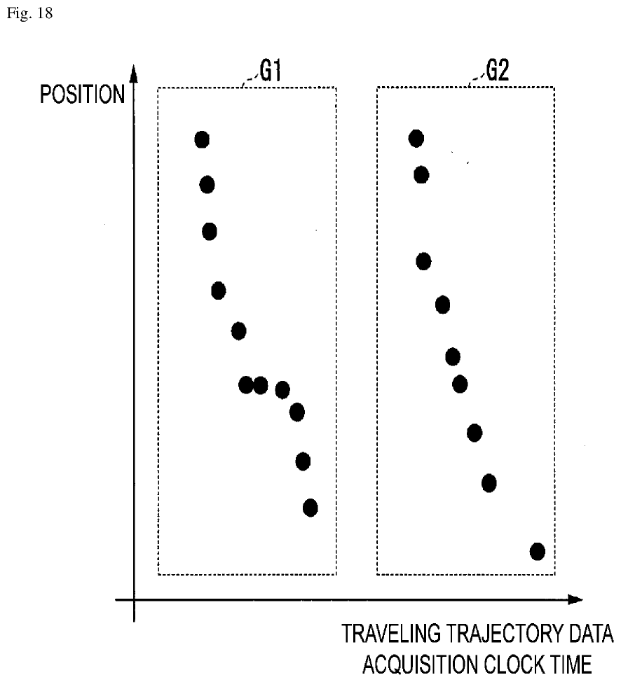

FIG. 18 is a diagram illustrating an exemplary result of the classification according to the second embodiment. In FIG. 18, the horizontal axis represents the traveling trajectory data acquisition clock time while the vertical axis represents the position indicated by the traveling trajectory data. FIG. 18 illustrates that the traveling trajectory data is classified into two clusters, namely a cluster G1 and a cluster G2. The black circles in FIG. 18 represent traveling trajectory data points.

Description will be returned to FIG. 17. After Step S405, the point cloud data acquisition count determination unit 134 acquires a statistical amount based on the traveling trajectory data acquisition clock times for each cluster obtained as a result of the classification. The statistical amount based on the traveling trajectory data acquisition clock time is, for example, a median at the traveling trajectory data acquisition clock time. The statistical amount based on the traveling trajectory data acquisition clock time may be, for example, a maximum value, a minimum value, or an average value.

Next, the point cloud data acquisition count determination unit 134 determines whether or not the maximum value of a difference in statistical values among the clusters based on the traveling trajectory data acquisition clock time in the (i+1)-th small area is equal to or greater than a predetermined difference (Step S407). Hereinafter, the difference in the statistical values among the clusters based on the traveling trajectory data acquisition clock time will be referred to as an acquisition clock time difference.

In a case in which the maximum value of the acquisition clock time difference is equal to or greater than the predetermined difference (Step S407: YES), the point cloud data acquisition count determination unit 134 determines that the mobile body 2 has passed through the (i+1)-th small area a plurality of times (Step S408). Next, the processing is returned to Step S404.

On the other hand, in a case in which the maximum value of the acquisition clock time is less than the predetermined difference in Step S407 (Step S407: NO), the point cloud data acquisition count determination unit 134 determines that the mobile body 2 has passed the (i+1)-th small area only once (Step S409). Next, the processing is returned to Step S404.

Note that the amount of change is not acquired for the first small area (i=1) because there is no 0-th small area.

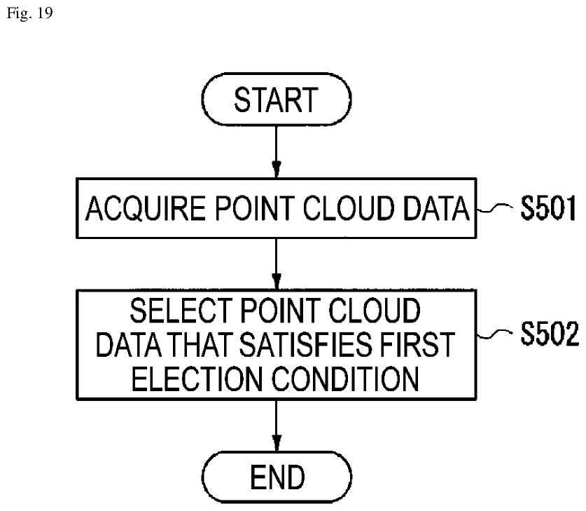

FIG. 19 is a flowchart illustrating an example of a specific processing flow performed by the point cloud data selection unit 135 to select point cloud data according to the second embodiment. The flow illustrated in FIG. 19 is executed after the execution of the main count determination processing.

The point cloud data selection unit 135 acquires the point cloud data acquired by the mobile body 2 in the multiple-passing area (Step S501). Next, the point cloud data selection unit 135 selects point cloud data that satisfies the first selection condition based on the classification result of the classification in Step S405 (Step S502).

After the execution of the flow illustrated in FIG. 19, the voxel splitting unit 132a executes the processing in Steps S103 to S106 illustrated in FIG. 6 based on the modified acquisition condition information instead of the acquisition condition information. Next, the calculation unit 133a executes the processing in Step S107 illustrated in FIG. 6 based on modified point cloud data instead of the point cloud data.

The shield factor calculation apparatus 1a according to the second embodiment configured as described above includes the point cloud data acquisition count determination unit 134, thus determines that the mobile body 2 has passed the same area a plurality of times, and calculates the shield factor based on the determination result. The shield factor calculation apparatus 1 can thus curb degradation of accuracy in calculation of the radio wave shielding date due to the mobile body 2 passing the same area a plurality of times.

### Modification Example of Second Embodiment

The predetermined selection condition may be, for example, a second selection condition, which will be described below. The second selection condition is a condition that the point cloud data is acquired by the mobile body 2 at a clock time indicated by a traveling trajectory data point belonging to the second target cluster. The second target cluster is a cluster that satisfies the following second cluster condition in a case in which the plurality of traveling trajectory data points when the mobile body 2 passes the multiple-passing area are classified into a plurality of clusters based on the clock times indicated by the traveling trajectory data points. The second condition is a condition that a predetermined statistical amount of distribution of the distance between the position of the mobile body 2 indicated by each element in a cluster and the transmitting station or the receiving station is the smallest in the plurality of clusters obtained as a result of the classification. The predetermined statistical amount may be, for example, a median, a maximum value, a minimum value, or an average value.

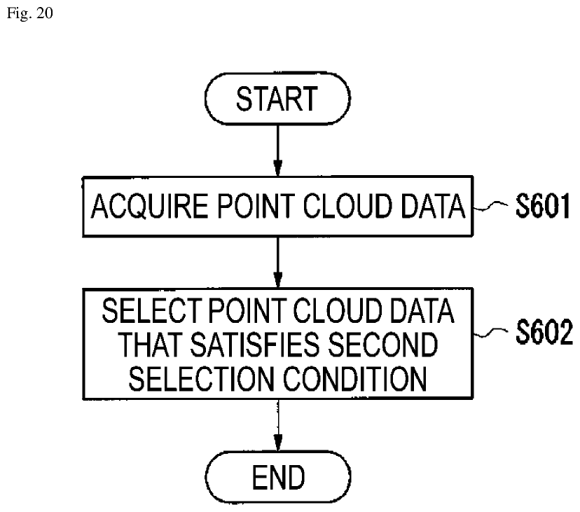

FIG. 20 is a flowchart illustrating an exemplary processing flow executed by the point cloud data selection unit 135 in a case in which the selection condition is the second selection condition according to the modification example of the second embodiment. The flow illustrated in FIG. 20 is executed after the execution of the main count determination processing.

The point cloud data selection unit 135 acquires the point cloud data acquired by the mobile body 2 in the multiple-passing area (Step S601). Next, the point cloud data selection unit 135 selects point cloud data that satisfies the second selection condition based on the classification result of the classification in Step S405 (Step S602).

After the execution of the flow illustrated in FIG. 20, the voxel splitting unit 132a executes the processing in Steps S103 to S106 illustrated in FIG. 6 based on the modified acquisition condition information instead of the acquisition condition information. Next, the calculation unit 133a executes the processing in Step S107 illustrated in FIG. 6 based on modified point cloud data instead of the point cloud data.

In a case in which the selection condition is the second selection condition, the shield factor calculation apparatus 1a can calculate the shield factor using the point cloud data located at a short distance. The shield factor calculation apparatus 1a can thus accurately calculate the radio wave shield factor between the wireless stations.

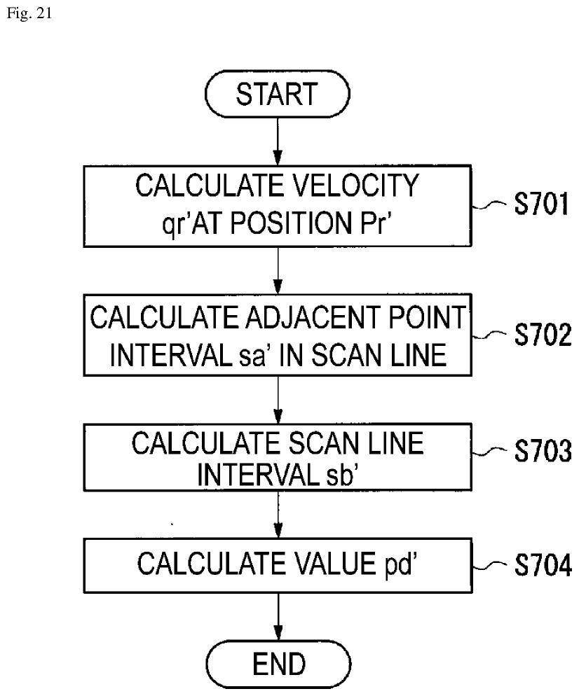

The predetermined selection condition may be, for example, a third selection condition, which will be described below. The third selection condition is a condition that the point cloud data is acquired by the mobile body 2 at a clock time indicated by a traveling trajectory data point belonging to a third target cluster. The third target cluster is a cluster that satisfies the following third cluster condition in a case in which a plurality of traveling trajectory data points when the mobile body 2 passes through the multiple-passing area are classified into a plurality of clusters based on the clock times indicated by the traveling trajectory data points. The third cluster condition is a condition that the density of point cloud data that can be acquired by the mobile body 2 from the earliest clock time to the latest clock time indicated by belonging traveling trajectory data points (hereinafter, referred to as “target point cloud data”) is highest from among the plurality of clusters obtained as a result of the classification. The target point cloud data is point cloud data acquired on the assumption that all the surroundings of the area are filled with a shielding object. The density of the target point cloud data is a density of point cloud data acquired on the assumption that all the surroundings of the area are filled with a shielding object. The density of the target point cloud data is acquired specifically in the procedure illustrated in FIG. 21 below.

FIG. 21 is a diagram illustrating an exemplary processing for calculating a density of target point cloud data according to the modification example. The processing illustrated in FIG. 21 is executed by functional units included in a control unit 13b such as a point cloud data selection unit 135, for example.

A velocity qr′ of the mobile body 2 at a position Pr′ indicated by traveling trajectory data belonging to each cluster is calculated based on the traveling trajectory data (Step S701). Next, a distance R′ from the position Pr′ to a base station is calculated based on the position Pc′ of the base station and the position Pr′. The base station is either the transmitting station or the receiving station. An adjacent point interval sa′ in the scan line is calculated based on the calculated distance R′, emission orientation information, and emission timing information (Step S702). The adjacent point interval sa′ in the scan line is calculated by Expression (6) below.

[Math. 6]

sa′=ω×R′ (6)

Next, a scan line interval sb′ is calculated based on the emission orientation information and the emission timing information (Step S703). The scan line interval sb′ is calculated by Expression (7) below.

$$\begin{matrix}[ Math . 7 ] & \\ {sb}^{′} = \frac{{qr}^{′}}{H} & ( 7 )\end{matrix}$$

Next, a value pd′ represented by Expression (8) below is calculated (Step S704).

$$\begin{matrix}[ Math . 8 ] & \\ {pd}^{′} = \frac{1}{{sa}^{′} \times {sb}^{′}} & ( 8 )\end{matrix}$$

The value pd′ is the density of the target point cloud data.

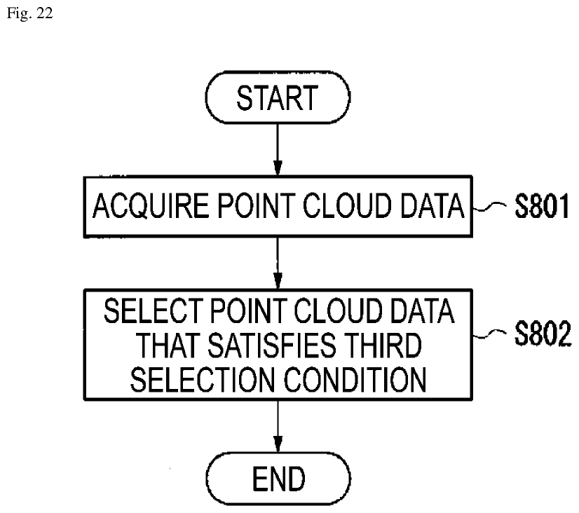

FIG. 22 is a flowchart illustrating an exemplary processing flow executed by the point cloud data selection unit 135 in a case in which the selection condition is the third selection condition according to the modification example of the second embodiment. The flow illustrated in FIG. 22 is executed after the execution of the main count determination processing.

The point cloud data selection unit 135 acquires the point cloud data acquired by the mobile body 2 in the multiple-passing area (Step S801). Next, the point cloud data selection unit 135 selects point cloud data that satisfies the third selection condition based on the classification result of the classification in Step S405 (Step S802).

After the execution of the flow illustrated in FIG. 22, the voxel splitting unit 132a executes the processing in Steps S103 to S106 illustrated in FIG. 6 based on the modified acquisition condition information instead of the acquisition condition information. Next, the calculation unit 133a executes the processing in Step S107 illustrated in FIG. 6 based on modified point cloud data instead of the point cloud data.

In a case in which the selection condition is the third selection condition, the shield factor calculation apparatus 1a can calculate the shield factor using the point cloud data with the highest density. The shield factor calculation apparatus 1a can thus accurately calculate the radio wave shield factor between the wireless stations.

Note that the point cloud data acquisition count determination unit 134 does not necessarily determine whether or not the small area that is a target of determination is the multiple-passing area through the processing illustrated in FIGS. 16 and 17. For example, the point cloud data acquisition count determination unit 134 may determine that the small area that is a target of determination is the multiple-passing area in a case in which the number of data items of the traveling trajectory data in the small area that is a target of determination is equal to or greater than a predetermined number. In such a case, the point cloud data acquisition count determination unit 134 determines that the small area that is a target of determination is not a multiple-passing area in a case in which the number of data items of the traveling trajectory data in the small area that is a target of determination is less than the predetermined number. Moreover, in such a case, any of the functional units included in the control unit 13a executes the classification processing in Step S405 in FIG. 17 before the point cloud data selection unit 135 selects the point cloud data that satisfies the selection condition. Any of the functional units included in the control unit 13a is, for example, the point cloud data acquisition count determination unit 134 or the point cloud data selection unit 135.

Note that the shield factor calculation apparatuses 1 and 1a may be implemented using a plurality of information processing apparatuses communicably connected via a network. In this case, each functional unit included in the shield factor calculation apparatus 1 may be implemented in a plurality of information processing apparatuses in a distributed manner. For example, the voxel splitting unit 132 and the calculation unit 133 may be implemented in different information processing apparatuses.

All or some of the functions in the shield factor calculation apparatus 1 and 1a may be realized using hardware such as an application specific integrated circuit (ASIC), a programmable logic device (PLD), or a field programmable gate array (FPGA). A program may be recorded in a computer-readable recording medium. The computer-readable recording medium is, for example, a portable medium such as a flexible disk, a magneto-optical disk, a ROM, or a CD-ROM, or a storage device such as a hard disk drive incorporated in a computer system. The program may be transmitted via an electrical communication line.

Although the embodiments of the present invention have been described above in detail with reference to the drawings hitherto, specific configurations are not limited to these embodiments and include any design or the like without departing from the gist of the present invention.

### REFERENCE SIGNS LIST

1, 1a Shield factor calculation apparatus
10 Display unit
11 Communication unit
12 Storage unit
13, 13a Control unit
2 Mobile body
21 Three-dimensional laser scanner
211 Emitting unit
212 Receiving unit
213 Data acquisition unit
131 Acquisition unit
132, 132a Voxel splitting unit
133, 133a Calculation unit
134 Point cloud data acquisition count determination unit
135 Point cloud data selection unit
901 Transitting station
902 Receiving station

1. A shield factor calculation apparatus comprising:
a processor; and
a storage medium having computer program instructions stored thereon, when executed by the processor, perform to:
select point cloud data that satisfies a predetermined selection condition from point cloud data acquired by a mobile body that acquires the point cloud data indicating a shielding object in a space between a transmitting station and a receiving station in a multiple-passing area that is a region through which the mobile body has passed a predetermined number of times or more from among areas through which the mobile body has passed;
split a Fresnel zone into a plurality of voxels with sizes corresponding to positions in the Fresnel zone, based on information indicating an acquisition condition when the mobile body acquires the point cloud data and information indicating an acquisition condition when the mobile body acquires the point cloud data in an area other than the multiple-passing area; and
calculate a shield factor of a radio wave directed from the transmitting station to the receiving station based on a position, a shape, and a size of a shielding voxel that is a voxel at a position indicated by at least either the point cloud data or the point cloud data acquired by the mobile body in the area other than the multiple-passing area, from among the plurality of voxels.

2. The shield factor calculation apparatus according to claim 1, wherein the selection condition is a condition that in a case in which a plurality of traveling trajectory data points indicating positions of the mobile body at the time of passing through the multiple-passing area and clock times when the mobile body is present at the positions are classified into a plurality of clusters based on the clock time, and when a cluster with the largest elements is defined as a first target cluster, the point cloud data is acquired by the mobile body at the clock time indicated by a traveling trajectory data point belonging to the first target cluster.

3. The shield factor calculation apparatus according to claim 1, wherein the selection condition is a condition that in a case in which a plurality of traveling trajectory data points indicating positions of the mobile body at the time of passing through the multiple-passing area and clock times when the mobile body is present at the positions are classified into a plurality of clusters based on the clock time, and when a cluster with a smallest predetermined statistical amount of distribution of a distance between each of the positions indicated by elements in the cluster and the transmitting station or the receiving station is defined as a second target cluster, the point cloud data is acquired by the mobile body at the clock time indicated by a traveling trajectory data point belonging to the second target cluster.

4. The shield factor calculation apparatus according to claim 1, wherein the selection condition is a condition that in a case in which a plurality of traveling trajectory data points indicating positions of the mobile body at the time of passing through the multiple-passing area and clock times when the mobile body is present at the positions are classified into a plurality of clusters based on the clock times, and when a cluster with a highest density of point cloud data that is able to be acquired by the mobile body from an earliest clock time to a latest clock time indicated by belonging traveling trajectory data points is defined as a third target cluster, the point cloud data is acquired by the mobile body at the clock time indicated by a traveling trajectory data point belonging to the third target cluster.

5. The shield factor calculation apparatus according to claim 1, wherein, on the assumption that a dataset of traveling trajectory data points indicating the positions of the mobile body and the clock times when the mobile body is present at the positions is defined as traveling trajectory data, a value obtained by dividing the number of times the mobile body passes through an area by an area of the area is defined as a traveling trajectory data density, each region in a case in which an entire area where the mobile body passes is split into U (U is an integer that is equal to or greater than two) regions that satisfy a predetermined condition is defined as a small area, and the small area through which the mobile body passes i-th earliest (i is an integer that is equal to or greater than 1 and equal to or less than U) is defined as an i-th small area, the point cloud data selection unit determines whether or not the amount of change in traveling trajectory data density between an (i+1)th small area and the i-th small area is equal to or greater than a predetermined threshold value, and in a case in which the amount of change is equal to or greater than a predetermined threshold value, the computer program instructions further perform to classifies the plurality of traveling trajectory data points acquired in the (i+1)-th small area based on a clock time indicated by the traveling trajectory data acquired in the (i+1)-th small area into a plurality of clusters, acquires a statistical amount based on the clock time indicated by the traveling trajectory data for each of the plurality of clusters resulted from the classification, and determines that the (i+1)-th small area is a multiple-passing area if a maximum value of a difference between the statistical values among the plurality of clusters is equal to or greater than a predetermined difference.

6. The shield factor calculation apparatus according to claim 1, wherein the computer program instructions further perform to determines the multiple-passing area such that a region in which the number of traveling trajectory data points indicating the positions of the mobile body and the clock time when the mobile body is present at the positions is equal to or greater than a predetermined number is the multiple-passing area.

7. A shield factor calculation method comprising:
selecting point cloud data that satisfies a predetermined selection condition from point cloud data acquired by a mobile body that acquires the point cloud data indicating a shielding object in a space between a transmitting station and a receiving station in a multiple-passing area that is a region through which the mobile body has passed a predetermined number of times or more from among areas through which the mobile body has passed;
splitting a Fresnel zone into a plurality of voxels with sizes corresponding to positions in the Fresnel zone, based on information indicating an acquisition condition when the mobile body acquires the point cloud data selected in the selecting of the point cloud data and information indicating an acquisition condition when the mobile body acquires the point cloud data in an area other than the multiple-passing area;
calculating a shield factor of a radio wave directed from the transmitting station to the receiving station based on a position, a shape, and a size of a shielding voxel that is a voxel at a position indicated by at least either the point cloud data selected in the selecting of the point cloud data or the point cloud data acquired by the mobile body in the area other than the multiple-passing area, from among the plurality of voxels.

8. A non-transitory computer-readable medium having computer-executable instructions that, upon execution of the instructions by a processor of a computer, cause the computer to function as the shield factor calculation apparatus according to claim 1.
